(19) United States
(12) Patent Application Publication
(10) Pub. No.: US 2020/0361553 A1
(43) Pub. Date: Nov. 19, 2020

(54) RIDER SUPPORT AND ADJUSTMENT STRUCTURE, AND SEAT POSITION AND ORIENTATION ADJUSTMENT STRUCTURE FOR BICYCLE

(71) Applicant: Peter Boutakis, North York (CA)

(72) Inventor: Peter BOUTAKIS, Markham (CA)

(21) Appl. No.: 15/733,397

(22) PCT Filed: Jan. 21, 2019
(86) PCT No.: PCT/CA2019/050075

§ 371 Date: Jul. 20, 2020

Related U.S. Application Data
(60) Provisional application No. 62/619,743, filed on Jan. 20, 2018.

(51) Int. Cl. B62J 1/08; B62K 19/36

(52) U.S. Cl. CPC B62J 1/08; B62K 19/36

(57) ABSTRACT

In an aspect, a seat position and orientation adjustment structure for a bicycle is provided and includes a seat position adjustment structure and a seat orientation adjustment structure, which are both connected to a seat post of the bicycle at least indirectly. The seat position adjustment structure includes a seat position adjustment structure release member that is actuatable to unlock the seat position adjustment structure so as to permit adjustment of a position of the saddle without permitting adjustment of an orientation of the saddle. The seat orientation adjustment structure includes a seat orientation adjustment structure release member that is actuatable to unlock the seat orientation adjustment structure so as to permit adjustment of the orientation of the saddle.

### CROSS-REFERENCE TO RELATED APPLICATIONS

This application claims the benefit of U.S. Provisional application 62/619,743, filed Jan. 20, 2018, the contents of which are incorporated herein by reference in their entirety.

### FIELD

The specification relates generally to seat adjustment structures for bicycles and other personal vehicles. In particular, the following relates to seat adjustment structures for folding bicycles.

### BACKGROUND OF THE DISCLOSURE

Adjustment structures for bicycle seats are well known. However many such structures have significant drawbacks. For example, many standard structures do not permit much adjustment of the seat. Some structures which are provided in addition to said standard structures wind up raising the height of the seat significantly which can be undesirable. Other problems exist as well with such structures. It would be desirable to provide a seat position adjustment structure that overcame one or more of these problems or other problems.

### SUMMARY OF THE DISCLOSURE

In one aspect, there is provided a rider support and adjustment structure for a bicycle having a longitudinal axis, comprising: a bicycle saddle having a first saddle rail and a second saddle rail, wherein the first and second saddle rails are laterally spaced apart from one another; a seat post rail that is connected to a seat post of the bicycle and which has a longitudinal rear end to a longitudinal front end; a saddle support body; a first saddle clamp that is connected to the saddle support body and holds the first saddle rail from the bicycle saddle and a second saddle clamp that is connected to the saddle support body and holds the second saddle rail from the bicycle saddle; a first seat post rail jaw and a second seat post rail jaw, wherein at least one of the first and second seat post rail jaws is movably connected to the saddle support body; a drive structure that is movable to drive the first and second seat post rail jaws to apply a clamping force on the seat post rail; and a release lever that is pivotable between a clamping position in which the release lever causes the drive structure to drive the first and second seat post rail jaws to clamp the seat post rail and a release position in which the release lever causes the first and second seat post rail jaws to relax the clamping force on the seat post rail, which permits movement of the saddle support body along the seat post rail between the longitudinal rear end and a longitudinal front end. In some embodiments, the seat post rail extends between the first saddle rail and the second saddle rail and wherein the first saddle rail and the second saddle rail at least partially overlap vertically with the seat post rail.

In another aspect, a seat position adjustment structure for a bicycle or other personal vehicle is provided and includes a seat post rail; a first seat post rail jaw and a second seat post rail jaw; a biasing member that urges the first and second seat post rail jaws towards applying a clamping force of the seat post rail; and a release lever that is pivotable between a first position in which the release lever permits the biasing member to drive the first and second seat post rail jaws towards clamping of the seat post rail and a second position in which the release lever causes the first and second seat post rail jaws to relax the clamping force on the seat post rail against the urging of the biasing member.

In another aspect, a seat position and orientation adjustment structure for a saddle of a bicycle is provided and includes a seat position adjustment structure and a seat orientation adjustment structure, which are both connected to a seat post of the bicycle, wherein the seat position adjustment structure includes a seat position adjustment structure release member that is actuatable to unlock the seat position adjustment structure so as to permit adjustment of a position of the saddle without permitting adjustment of an orientation of the saddle, and wherein the seat orientation adjustment structure includes a seat orientation adjustment structure release member that is actuatable to unlock the seat orientation adjustment structure so as to permit adjustment of the orientation of the saddle.

### BRIEF DESCRIPTIONS OF THE DRAWINGS

For a better understanding of the various embodiments described herein and to show more clearly how they may be carried into effect, reference will now be made, by way of example only, to the accompanying drawings in which:

FIG. 1 shows a bicycle in accordance with one embodiment of the present disclosure;

FIG. 2 is a side view of a seat position adjustment structure for the bicycle shown in FIG. 1;

FIG. 3 is a perspective view of the seat position adjustment structure shown in FIG. 2;

FIG. 4 is a magnified sectional side view of the seat position adjustment structure shown in FIG. 2 in a clamping position, without a bicycle seat shown;

FIG. 5 is a magnified perspective view of the seat position adjustment structure shown in FIG. 4;

FIG. 6 is a magnified sectional side view of the seat position adjustment structure shown in FIG. 2 in a release position;

FIG. 7 is a perspective view of a seat position adjustment structure in accordance with another embodiment of the present disclosure with a release lever in a locking position;

FIG. 8 is a perspective view of the seat position adjustment structure shown in FIG. 7 with a release lever in a release position;

FIG. 9 is a side elevation view of the seat position adjustment structure shown in FIG. 7;

FIG. 10 is a front elevation view of the seat position adjustment structure shown in FIG. 7;

FIG. 11 is a perspective view of an optional seat orientation adjustment structure shown in FIG. 7 in a raised position;

FIG. 12 is a perspective view of the optional seat orientation adjustment structure shown in FIG. 7 in a lowered position;

FIG. 13 is a perspective view of the seat position adjustment structure with the optional seat orientation adjustment structure;

FIG. 14 is a perspective sectional view of the seat position adjustment structure with the optional seat orientation adjustment structure.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

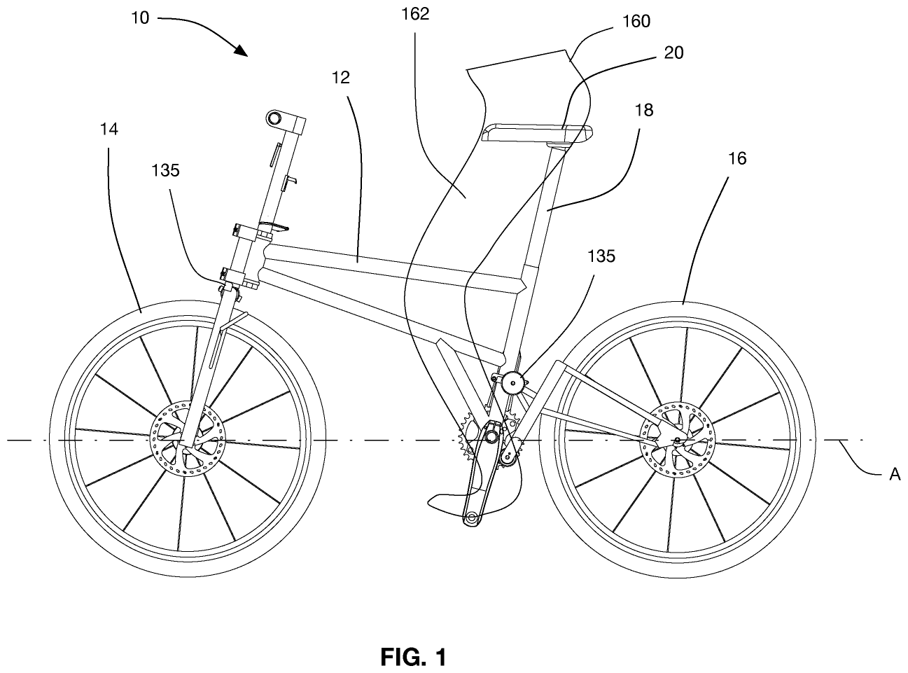

Reference is made to FIG. 1. A bicycle 10 is provided that includes a bicycle frame 12, a first wheel 14 and a second wheel 16. The frame 12 and first and second wheels 14 and 16 define a longitudinal axis A for the bicycle, which is the direction that the bicycle travels in on level ground when its first wheel (the front wheel) is straight. The bicycle frame 12 may be any suitable type of bicycle frame that is known in the art. The bicycle frame 12 includes a seat post 18 that holds a bicycle seat 20 (also called a bicycle saddle 20, which may, for simplicity be referred to as a saddle 20). The saddle 20 is shown in a simplified form in FIG. 1.

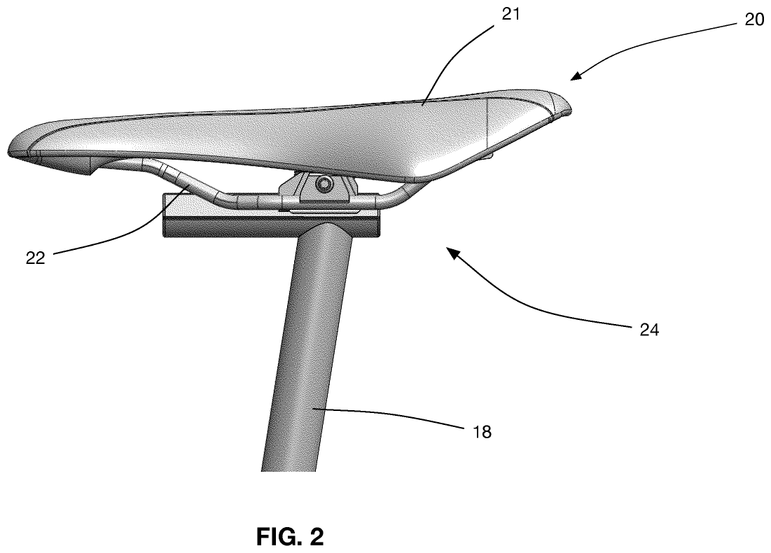

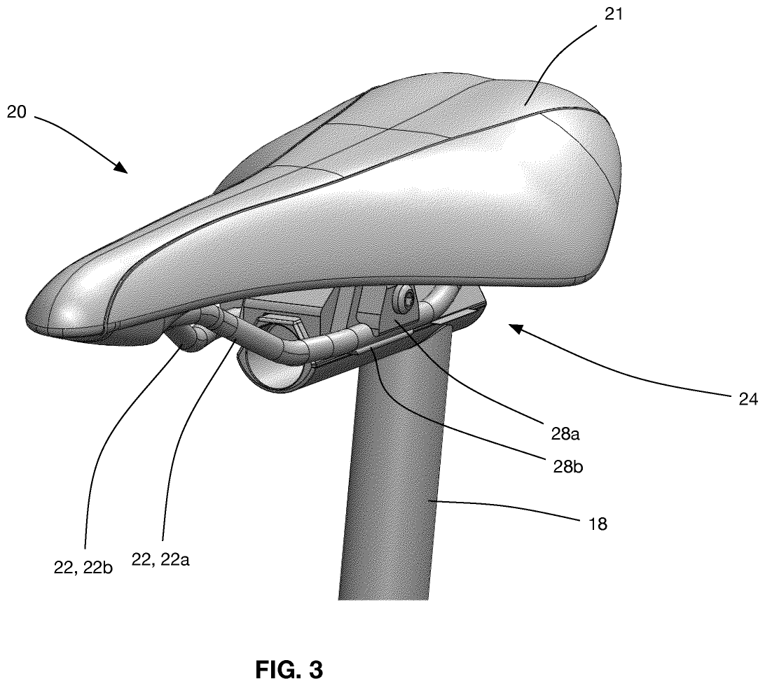

Reference is made to FIG. 2. The saddle 20 includes a seat body 21 which may have any suitable construction but which typically includes a shell and a cover, and first and second saddle rails 22 (shown individually at 22a and 22b in FIG. 3) which are laterally spaced apart from one another. A seat position adjustment structure 24 is provided, which allows a user to quickly change the position of the seat 20 without requiring the use of tools. The seat position adjustment structure 24 allows the user to move the seat 20 between a forward positions and rearward positions, allowing the user to select between their preferred riding positions and stowage positions.

This is beneficial for several purposes, including:

1. Making a folding bike more compact when in the folded position without having to remove the seat post; and

2. Adjusting the fore-aft position of the saddle for a bicycle that is used by many different riders, such as a bike sharing bike.

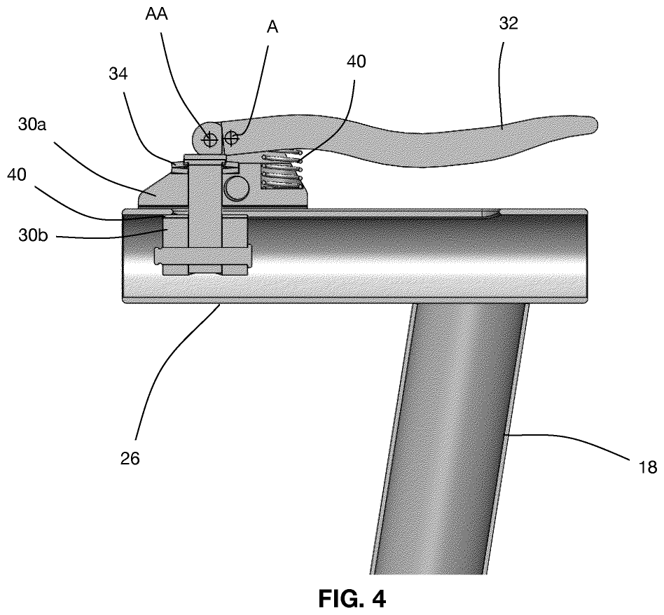

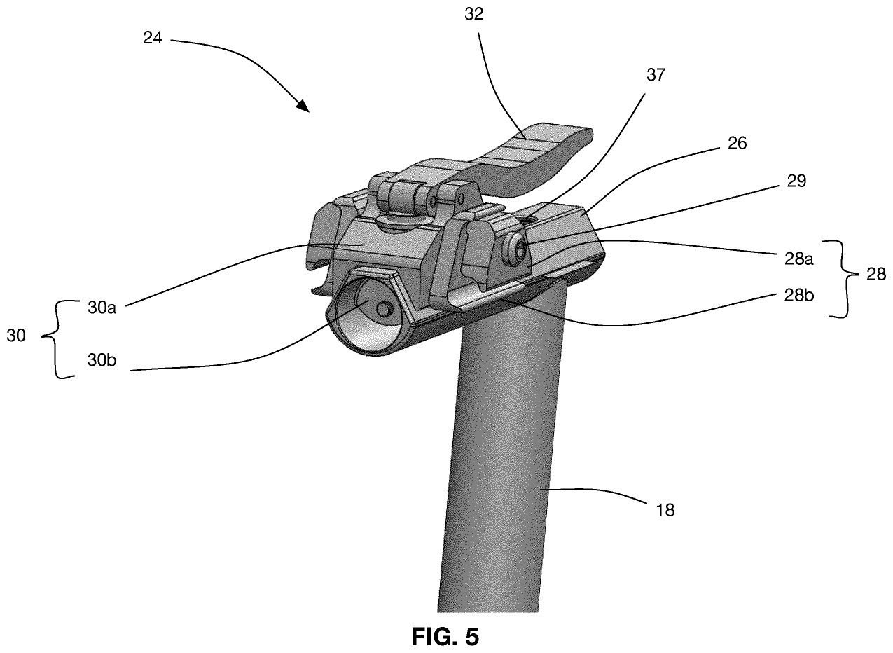

Referring to FIGS. 4 and 5, the seat position adjustment structure 24 includes a seat post rail 26 that is connected to the seat post 18, a seat connector 28 that holds the seat 20, a seat post rail clamping structure 30, a release lever 32, and a seat post rail clamping structure biasing member 34 (FIG. 4). The seat connector 28 connects to the seat 20 in any suitable way, e.g. by a seat clamping structure that includes first and second seat rail jaws 28a and 28b that are connected via a threaded fastener 29 to clamp the saddle rails 22 (FIG. 3).

The seat post rail clamping structure 30 includes a first seat post rail jaw 30a and a second seat post rail jaw 30b. The seat post rail jaws 30a and 30b clamp the seat post rail 26 to hold the seat position adjustment structure 24 to the seat post rail 26 in place thereon so as to lock the seat 20 in a user-selectable position.

The seat post rail jaws 30a and 30b are urged towards one another by a seat post rail clamping structure pin 36 and the seat post rail clamping structure biasing member 34. The pin 36 passes through a slot 37 extends between the first and second seat post rail jaws 30a and 30b and is slidably connected to at least one of the jaws 30a and 30b. The seat post rail clamping structure biasing member 34 may be a compression spring that acts between a first end 38 of the pin 36 and the first jaw 30a thereby urging the first jaw 30a (the one that is slidable on the pin 36) towards the second jaw 30b (which in the present example is not slidable on the pin 36). The biasing member 34 is shown in the present example to be made up of a plurality of Belleville washers, however it will be understood that it could be made up of any suitable structure such as a suitable high-force helical compression spring.

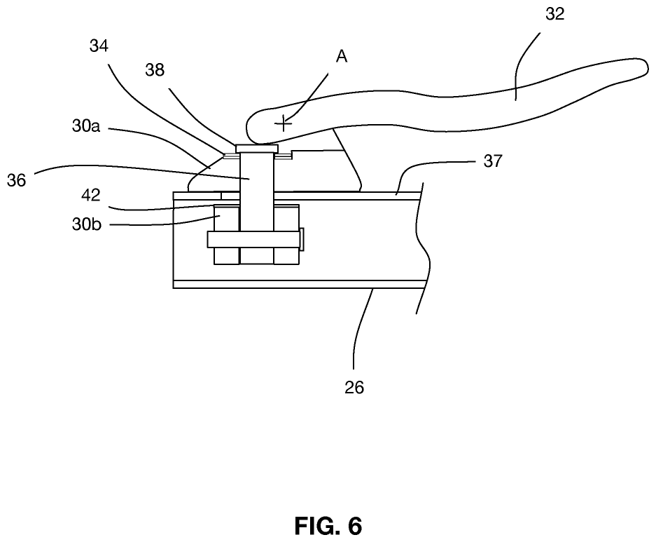

The release lever 32 is pivotally connected about a first pivot axis A to the first jaw 30a and is pivotally connected about a second pivot axis AA to the first end 38 of the pin 36. When the release lever 32 is in a first position (FIG. 4), it permits the biasing member 34 to cause the jaws 30a and 30b to clamp the seat post rail 26. When the release lever 32 is in a second position (FIG. 6) it drives the pin 36 downward (against the urging of the biasing member 34) so as to relax the clamping force of the jaws 30a and 30b on the seat post rail 26. Once in the second position, the user can then slide the seat 20 along with the adjustment structure 24 along the seat post rail 26. Once it is in the desired position, the user can then simply release the lever 32 and the clamping force of the jaws 30a and 30b is reapplied by the biasing member 34. It is optionally possible for the pin 36 to not be pivotally connected to the pin 36 and could instead simply abut the end 38 of the pin 36. In the example shown, to move the saddle 20, the user lifts the lever 32 which compresses the high force spring 34. The lever 32 could, instead of driving the pin 36 downwards, directly engage and compress the spring 34 so as to remove the force of the spring 34 on the pin 36, thereby relaxing the clamping force of the jaws 30a and 30b on the rail 26.

A release lever anti-rattle biasing member 40 is shown, which urges the release lever 32 to a position wherein it abuts the head of the pin 36 but does not cause unclamping of the jaws 30a and 30b. This inhibits rattling of the lever 32 during use of the bicycle 10. This is an optional feature and could be omitted from the adjustment structure 24.

The release lever 32 may be a single lever directly connected to the first jaw 30a as shown and may be directly accessed by the user's hand. Alternatively the release lever 32 may be part of a linkage or series of levers that modify the force applied, so as to change the angular range of movement and/or force applied by the user, and/or the position at which the user's hand accesses the adjustment structure 24 for releasing the jaws 30a and 30b.

A plastic shim shown at 42 may be provided between the second jaw 30b and the seat post rail 26 to facilitate smooth movement therebetween during sliding of the adjustment structure 24 along the rail 26.

Disclosed above is an example only of a suitable seat position adjustment structure. Any other suitable adjustment structure may be used.

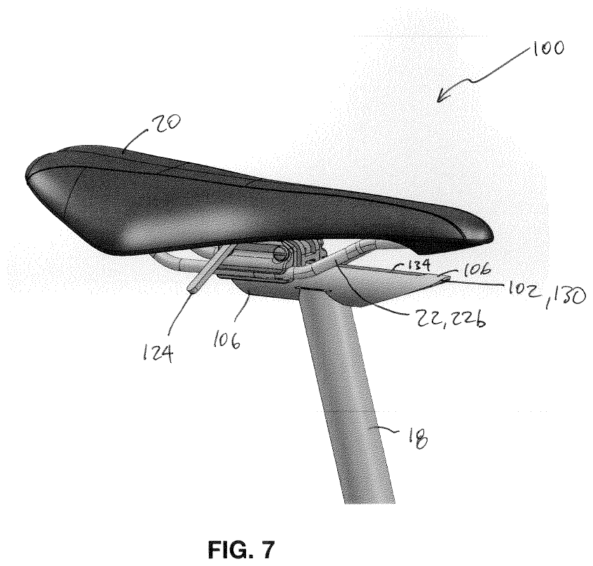

The seat position adjustment structure 24 disclosed in FIGS. 1-6 form part of a rider support and adjustment structure 50 for the bicycle 10. Another example of a rider support and adjustment structure is shown at 100 in FIG. 7.

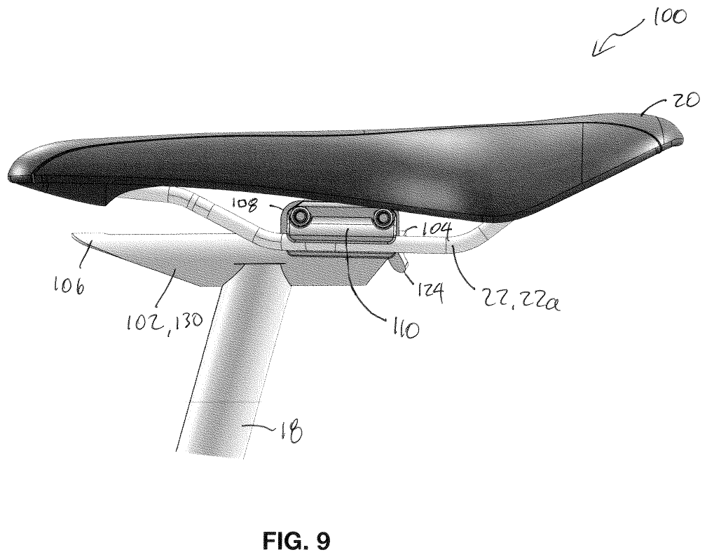

The rider support and adjustment structure 100 includes the bicycle saddle 20, and a seat position and orientation adjustment structure 101, which includes a seat post rail 102 that is connected to the seat post 18 of the bicycle 10 and which has a longitudinal rear end 104 to a longitudinal front end 106. For greater certainty, it will be noted that the longitudinal rear end 104 need not be directly longitudinally aligned with the longitudinal front end 106. The longitudinal rear end 104 is simply rearward by some amount relative to the longitudinal front end 106 but may be vertically displaced relative to the longitudinal front end 106. The rider support and adjustment structure 100 includes a saddle support body 108. A first saddle clamp 110 is connected to the saddle support body 108 and holds the first saddle rail 22a from the bicycle saddle 20 and a second saddle clamp 112 is also connected to the saddle support body 108 and holds the second saddle rail 22b from the bicycle saddle 20. In some embodiments, the first saddle clamp 110 and the second saddle clamp 112 are positioned such that the seat post rail 102 extends between the first saddle rail 22a and the second saddle rail 22b and such that the first saddle rail 22a and the second saddle rail 22b at least partially overlap vertically with the seat post rail 102, as can be seen in FIG. 9.

The rider support and adjustment structure 100 further includes a first seat post rail jaw 104 and a second seat post rail jaw 116. At least one of the first and second seat post rail jaws 114 and 116 is movably connected to the saddle support body 102. In the present example, the first seat post rail jaw 114 is fixedly connected to the saddle support body 108 and the second seat post rail jaw 116 movably connected to the saddle support body 108 as explained further below.

A drive structure 118 is movable to drive the first and second seat post rail jaws 114 and 116 to apply a clamping force on the seat post rail 102. In the present example, the drive structure 118 includes an externally threaded member 120 that extends from one of the saddle support body 108 and the second seat post rail jaw 116, and an internally threaded surface 122 that receives the externally threaded member 120 and which is positioned in the other of the saddle support body 108 and the second seat post rail jaw 116. In the present example, the externally threaded member 120 extends from the saddle support body 108 and the internally threaded surface 122 is provided on the second seat post rail jaw 116.

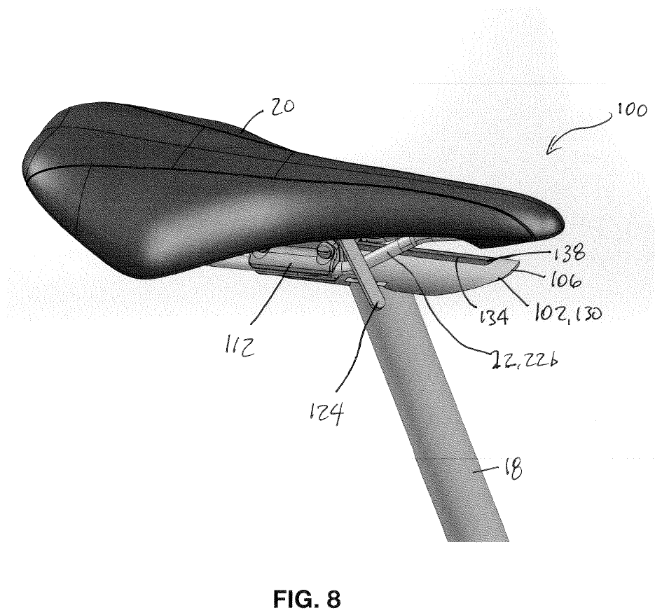

A release lever 124 is pivotable between a clamping position (FIG. 7) in which the release lever 124 causes the drive structure 118 to drive the first and second seat post rail jaws 114 and 116 to clamp the seat post rail 102, and a release position (FIG. 8) in which the release lever 124 causes the first and second seat post rail jaws 114 and 116 to relax the clamping force on the seat post rail 102, which permits movement of the saddle support body 108 along the seat post rail 102 between the longitudinal rear end 104 and the longitudinal front end 106.

In the present example, pivoting of the release lever 124 to the clamping position rotates one of the externally threaded and internally threaded members 120 and 122 relative to the other so as to drive linear movement of the first and second seat post rail jaws 114 and 116 towards each other to clamp the seat post rail 102, so as to fix the position of the saddle support body 108 on the seat post rail 102. Pivoting of the release lever 124 to the release position rotates the one of the externally threaded and internally threaded members 120 and 122 relative to the other so as to drive linear movement of the first and second seat post rail jaws 114 and 116 away from each other to unclamp the seat post rail 102 (i.e. relax the clamping force on the seat post rail 102), so as to permit movement of the position of the saddle support body 108 along the seat post rail 102. In the present example, the release lever 124 is fixedly connected to the externally threaded member 120, such that pivoting of the release lever 124 causes rotation of the externally threaded member 120 relative to the internally threaded surface 122. The externally threaded member 120 is rotatably connected to the saddle support body 108 and the second seat post rail jaw 116 which has the internally threaded surface 122 is unable to rotate due to its relationship with the seat post rail 102. More specifically, the seat post rail 102 in the present example is a tube 130 and the first seat post rail jaw 114 is on a top surface 132 of the tube 130 and the second seat post rail jaw 116 is inside the tube 130. The tube 130 includes a slot 134 and the drive structure 118 passes through the slot 134 into the tube 130 to hold the second seat post rail jaw 116. Thus both the first and second seat post rail jaws 114 and 116 clamp against the same portion of the rube 130, thereby reducing the tendency to warp or damage the rube 130 with the clamping force.

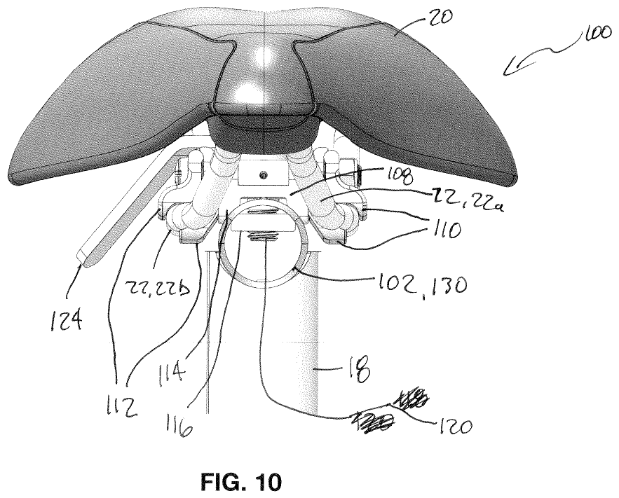

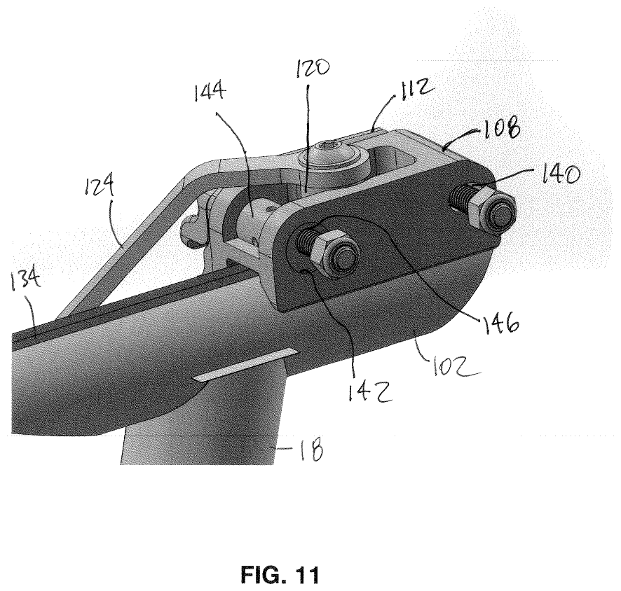

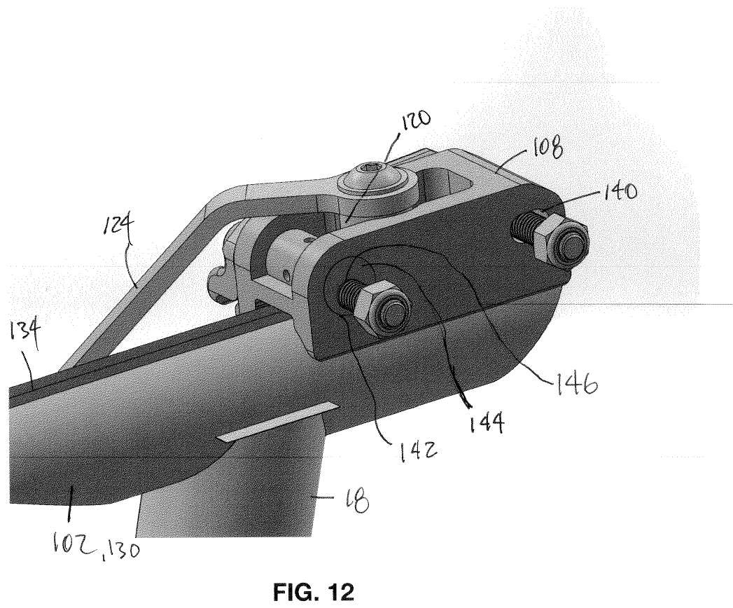

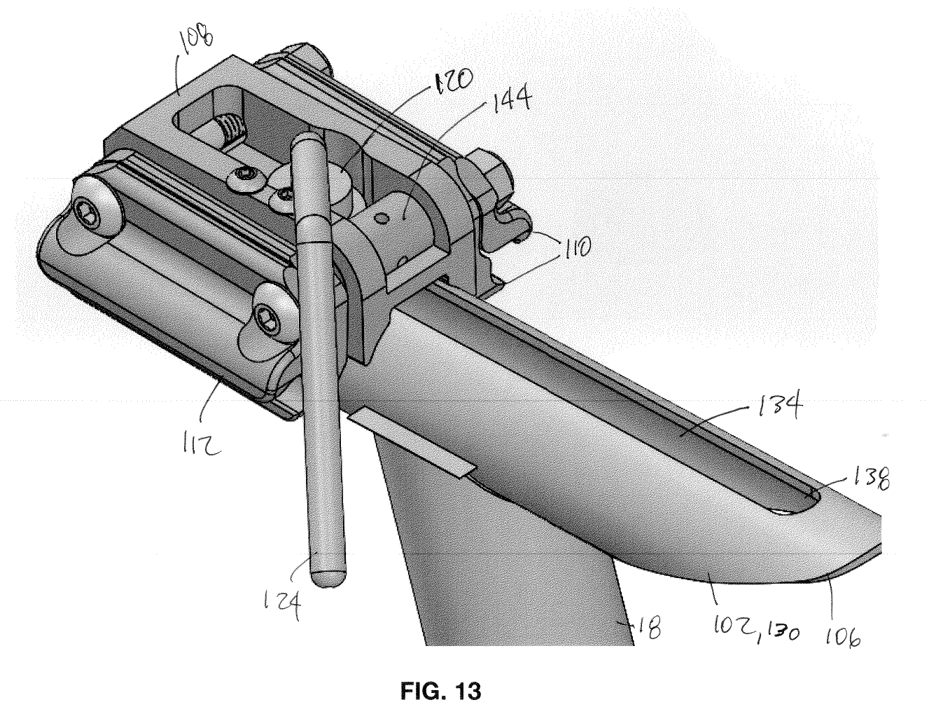

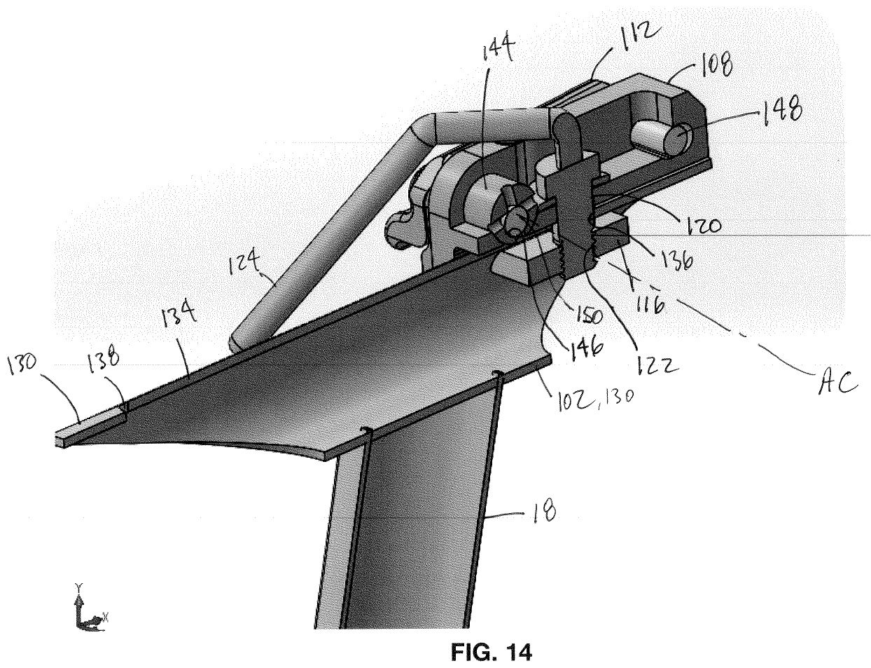

Providing the positional adjustment to the saddle 20 is advantageous in that the position of the saddle 20 can be adjusted toollessly and quickly. Furthermore, on a typical bicycle the saddle adjustment bolts and nuts, when loosened, will also result in a loss of the angular position (i.e. the orientation) the saddle, thereby necessitating the refinding of the desired orientation when adjusting the position of the saddle. This is not desirable. By contrast, the system shown in FIGS. 7-14 permits adjustment of the position of the saddle 20 without affecting the orientation of the saddle.

Additionally, in some embodiments, the bicycle 10 is a folding bicycle, having at least one hinge 135 in the frame to permit the frame to be folded, making the folding bicycle 10 convertible between a stowage position in which the bicycle 10 is folded, and a use position in which the bicycle 10 appears as shown in FIG. 1. A description of how the bicycle 10 may fold is provided in PCT publication WO2018064763, the contents of which are hereby incorporated fully by reference. When the bicycle 10 is in the stowage position, (e.g. as shown in FIG. 1f of that publication), it may be desirable to be able to move the saddle forward sufficiently that the saddle no longer extends rearward of the seat post, thereby shrinking further the overall volumetric footprint of the bicycle 10. A typical position adjustment mechanism for a bicycle saddle such as the saddle 20 does not permit the saddle 20 to move forward sufficiently to move past the seat post. In some embodiments, the seat post rail 102 is configured to permit this.

Additionally, the structure described herein may be configured to permit quick movement of the saddle 20 forward when the bicycle 10 is in the stowage position and quick movement back to the desired riding position when the bicycle 10 is in the use position without having to take time to find the desired riding position. For example, the slot 134 has a rear end 136 and a front end 138. The saddle support body 108 can be positioned as far back in the slot 134 as possible (i.e. such that the externally threaded member 120 is abutted with the rear end 136 of the slot 134, and with it there, the saddle's position in the first and second saddle clamps can be set to the desired position for riding when the bicycle 10 is in the use position. When the bicycle 10 is folded the saddle and the saddle support body 108 can simply be moved as far forward as desired. When it is desired to ride the bicycle 10, the saddle support body 108 can simply be pulled back to the rear end 136 of the slot 134 and the saddle 20 will be in the desired riding position.

In order to provide sufficient positional adjustability, the slot 134 may permit approximately 9 cm or more of movement of the saddle support body 108 and therefore of the saddle 20. It will be noted that a typical saddle support structure on a typical bicycle permits approximately 2.4 cm of adjustment. It will further be noted that the positionable adjustment provided for the saddle 20 may in some embodiments such as the present example, still be available in its entirety in spite of providing the additional approximately 9 cm of adjustment.

Additionally, it will be noted that the release lever 124 extends underneath the saddle 20 and does not extend laterally past the saddle 20 when in the clamping position, and extends laterally past the saddle 20 when in the release position so as to present an interference with a leg of the rider when the rider is sitting on the saddle 20 and pedaling the bicycle 10. A bottom portion of the rider is shown schematically at 160 in FIG. 1. Their leg is shown at 162.

A seat orientation adjustment structure is optionally provided with the bicycle 10. In the present example, the saddle support body 108 has a rear clamp pass-through aperture 140 and a forward clamp pass-through aperture 142. The rear clamp pass-through aperture 140 extends laterally through the saddle support body 108, and the forward clamp pass-through aperture 142 extends laterally through the saddle support body 108.

An adjustment cylinder 144 having an adjustment cylinder axis AC extends laterally in a first one of the rear and forward clamp pass-through apertures 140 and 142 (in the present example the forward clamp pass-through aperture 142). The adjustment cylinder 144 includes an adjustment cylinder pass-through aperture 146 that is offset from the adjustment cylinder axis AC. The first saddle clamp 110 and the second saddle clamp 112 are connected to one another by a rear cross support 148 and by a forward cross-support 150. A first one of the rear and forward cross-supports 148 and 150 (in the present example, the forward cross-support 150) passes through the first one of the rear and forward clamp pass-through apertures 140 and 142, and through the adjustment cylinder pass-through aperture 146, and a second one of the rear and forward cross-supports 148 (in the present example, the rearward cross-support 148) and 150 passes through a second one of the rear and forward clamp pass-through apertures 140 and 142 (in the present example, the rearward clamp pass-through aperture 140).

Rotation of the adjustment cylinder 144 controls an elevation of the adjustment cylinder pass-through aperture 146, thereby changing an elevation of the first one of the rear and forward cross-supports (e.g. forward cross-support 150) relative to the second one of the rear and forward cross-supports (e.g. rearward cross-support 148), thereby changing an orientation of the saddle 20 relative to the saddle support body 108.

To accommodate the fore/aft (i.e. longitudinal) positional change in the saddle clamps 110 and 112 that comes with rotation of the adjustment cylinder 144, the second one of the rear and forward clamp pass-through apertures 140 and 142 may be slotted.

Based on the above, it can be said that the saddle support body 108 has at least one clamp pass-through aperture (140, 142) and that an adjustment cylinder (e.g. shown at 144) having an adjustment cylinder axis AC extends laterally in a first one of the at least one clamp pass-through aperture (140, 142), wherein the adjustment cylinder includes a clamp support structure (in the present example, the adjustment cylinder aperture 146) that supports one of the rear and forward ends of the first and second saddle support clamps 110 and 112 (the rearward end of which is shown at 150 and the forward end of which is shown at 152). The clamp support structure is offset from the adjustment cylinder axis AC, such that rotation of the adjustment cylinder 144 controls an elevation of the clamp support structure, thereby changing an elevation of the one of the rear and forward ends 150 and 152 of the first and second saddle support clamps 110 and 112 relative to the other of the rear and forward ends 150 and 152 of the first and second saddle support clamps 110 and 112, thereby changing an orientation of the saddle 20 relative to the saddle support body 108.

Thus it may be said that a seat position and orientation adjustment structure for a bicycle is provided and includes a seat position adjustment structure (shown at 101) and a seat orientation adjustment structure, which are both connected to a seat post of the bicycle at least indirectly. The seat position adjustment structure includes a seat position adjustment structure release member that is actuatable to unlock the seat position adjustment structure so as to permit adjustment of a position of the saddle without permitting adjustment of an orientation of the saddle. The seat orientation adjustment structure includes a seat orientation adjustment structure release member that is actuatable to unlock the seat orientation adjustment structure so as to permit adjustment of the orientation of the saddle.

Persons skilled in the art will appreciate that there are yet more alternative implementations and modifications possible, and that the above examples are only illustrations of one or more implementations. The scope, therefore, is only to be limited by the claims appended hereto and any amendments made thereto.

1. A rider support and adjustment structure for a bicycle having a longitudinal axis, comprising:
a bicycle saddle having a first saddle rail and a second saddle rail, wherein the first and second saddle rails are laterally spaced apart from one another;
a seat post rail that is connected to a seat post of the bicycle and which has longitudinal rear end to a longitudinal front end;
a saddle support body;
a first saddle clamp that is connected to the saddle support body and holds the first saddle rail from the bicycle saddle and a second saddle clamp that is connected to the saddle support body and holds the second saddle rail from the bicycle saddle, such that the seat post rail extends between the first saddle rail and the second saddle rail and wherein the first saddle rail and the second saddle rail at least partially overlap vertically with the seat post rail,
a first seat post rail jaw and a second seat post rail jaw, wherein at least one of the first and second seat post rail jaws is movably connected to the saddle support body;
a drive structure that is movable to drive the first and second seat post rail jaws to apply a clamping force on the seat post rail; and
a release lever that is pivotable between a clamping position in which the release lever causes the drive structure to drive the first and second seat post rail jaws to clamp the seat post rail and a release position in which the release lever causes the first and second seat post rail jaws to relax the clamping force on the seat post rail, which permits movement of the saddle support body along the seat post rail between the longitudinal rear end and a longitudinal front end.

2. A rider support and adjustment structure as claimed in claim 1, wherein the seat post rail is a tube and the first seat post rail jaw is on a top surface of the tube and the second seat post rail jaw is inside the tube, wherein the tube includes a slot and the drive structure passes through the slot into the tube to hold the second seat post rail jaw.

3. A rider support and adjustment structure as claimed in claim 1, wherein the drive structure includes an externally threaded member that extends from one of the saddle support body and the second seat post rail jaw, and an internally threaded surface that receives the externally threaded member and which is positioned in the other of the saddle support body and the second seat post rail jaw, wherein pivoting of the lever to the clamping position rotates one of the externally threaded and internally threaded members relative to the other so as to drive linear movement of the first and second seat post rail jaws towards each other to clamp the seat post rail.

4. A rider support and adjustment structure as claimed in claim 1, wherein the saddle support body has a rear clamp pass-through aperture and a forward clamp pass-through aperture, wherein the rear clamp pass-through aperture extends laterally through the saddle support body, and the forward clamp pass-through aperture extends laterally through the saddle support body,
wherein an adjustment cylinder having an adjustment cylinder axis extends laterally in a first one of the rear and forward clamp pass-through apertures, wherein the adjustment cylinder includes an adjustment cylinder pass-through aperture that is offset from the adjustment cylinder axis,
and wherein the first saddle clamp and the second saddle clamp are connected to one another by a rear cross support and by a forward cross-support, wherein a first one of the rear and forward cross-supports passes through the first one of the rear and forward clamp pass-through apertures and through the adjustment cylinder pass-through aperture, and a second one of the rear and forward cross-supports passes through a second one of the rear and forward clamp pass-through apertures,
wherein rotation of the adjustment cylinder controls an elevation of the adjustment cylinder pass-through aperture, thereby changing an elevation of the first one of the rear and forward cross-supports relative to the second one of the rear and forward cross-supports, thereby changing an orientation of the saddle relative to the saddle support body.

5. A rider support and adjustment structure as claimed in claim 1, wherein the saddle support body has at least one clamp pass-through aperture, wherein an adjustment cylinder having an adjustment cylinder axis extends laterally in a first one of the at least one clamp pass-through aperture, wherein the adjustment cylinder includes a clamp support structure that supports one of the rear and forward ends of the first and second saddle support clamps, wherein the clamp support structure is offset from the adjustment cylinder axis, such that rotation of the adjustment cylinder controls an elevation of the clamp support structure, thereby changing an elevation of the one of the rear and forward ends of the first and second saddle support clamps relative to the other of the rear and forward ends of the first and second saddle support clamps, thereby changing an orientation of the saddle relative to the saddle support body.

6. A rider support and adjustment structure as claimed in claim 1, wherein the release lever extends underneath the saddle and does not extend laterally past the saddle when in the clamping position, and extends laterally past the saddle when in the release position so as to present an interference with a leg of the rider when the rider is sitting on the saddle and pedaling the bicycle.

7. A seat position adjustment structure for a bicycle or other personal vehicle, comprising:
a seat post rail;
a first seat post rail jaw and a second seat post rail jaw;
a biasing member that urges the first and second seat post rail jaws towards applying a clamping force of the seat post rail; and
a release lever that is pivotable between a first position in which the release lever permits the biasing member to drive the first and second seat post rail jaws towards clamping of the seat post rail and a second position in which the release lever causes the first and second seat post rail jaws to relax the clamping force on the seat post rail against the urging of the biasing member.

8. A seat position adjustment structure for a bicycle, comprising:
a seat position adjustment structure and a seat orientation adjustment structure, which are both connected to a seat post of the bicycle,
wherein the seat position adjustment structure includes a seat position adjustment structure release member that is actuatable to unlock the seat position adjustment structure so as to permit adjustment of a position of the saddle without permitting adjustment of an orientation of the saddle,
and wherein the seat orientation adjustment structure includes a seat orientation adjustment structure release member that is actuatable to unlock the seat orientation adjustment structure so as to permit adjustment of the orientation of the saddle.
